(19) United States
(12) Patent Application Publication
(10) Pub. No.: US 2024/0429654 A1
(43) Pub. Date: Dec. 26, 2024

(54) Connector Housing Assembly and Connector

(71) Applicants: Tyco Electronics (Suzhou) Ltd., Suzhou City (CN); Tyco Electronics (Shanghai) Co., Ltd., Shanghai (CN)

(72) Inventors: Shuanglin (Seven) Yuan, Suzhou (CN); Feng (Charles) Wan, Shanghai (CN); Zhaowen Zhou, Shanghai (CN)

(73) Assignees: Tyco Electronics (Suzhou) Ltd., Suzhou City (CN); Tyco Electronics (Shanghai) Co., Ltd., Shanghai (CN)

(21) Appl. No.: 18/754,019

(22) Filed: Jun. 25, 2024

(30) Foreign Application Priority Data
Jun. 25, 2023 (CN) 202321610684.8

(51) Int. Cl. H01R 13/629

(52) U.S. Cl. CPC H01R 13/62955

(57) ABSTRACT

A connector housing assembly includes a housing, a top cover installed on the housing and formed with an elastic cantilever on its top wall, a lever member rotatably connected to the housing and rotatable between a locked position and an unlocked position, and a safety member. The safety member is movably installed on the top cover and movable between a safety position that is engaged with the lever member and an initial position that is separated from the lever member. When the safety member is in the safety position, the lever member is held in the locked position by the safety member, so that the lever member cannot be unlocked.

### CROSS-REFERENCE TO RELATED APPLICATION

This application claims the benefit of Chinese Patent Application No. CN202321610684.8 filed on Jun. 25, 2023 in the State Intellectual Property Office of China, the whole disclosure of which is incorporated herein by reference.

### FIELD OF THE INVENTION

Embodiments of the present disclosure relate to a connector housing assembly and a connector comprising the connector housing assembly.

### BACKGROUND

In the prior art, a connector typically includes a housing, a top cover installed on the housing, and a lever member rotatably connected to the housing. The lever member can be rotated between a locked position that locks the top cover to the housing and an unlocked position that allows the top cover to separate from the housing. However, in the prior art, the lever member of the connector is easily accidentally pushed to the unlocked position, affecting the reliability of the connector's use.

### SUMMARY

According to an embodiment of the present disclosure, a connector housing assembly includes a housing, a top cover installed on the housing and formed with an elastic cantilever on its top wall, a lever member rotatably connected to the housing and rotatable between a locked position and an unlocked position, and a safety member. The safety member is movably installed on the top cover and movable between a safety position that is engaged with the lever member and an initial position that is separated from the lever member. When the safety member is in the safety position, the lever member is held in the locked position by the safety member, so that the lever member cannot be unlocked.

### BRIEF DESCRIPTION OF THE DRAWINGS

The invention will now be described by way of example with reference to the accompanying Figures, of which:

FIG. 1 shows an illustrative perspective view of a connector housing assembly according to an exemplary embodiment of the present invention;

FIG. 2 shows an illustrative perspective view of a lever member according to an exemplary embodiment of the present invention;

FIG. 3 shows an illustrative perspective view of a top cover according to an exemplary embodiment of the present invention;

FIG. 4 shows a longitudinal sectional view of the top cover when viewed from the front side according to an exemplary embodiment of the present invention;

FIG. 5 shows a longitudinal sectional view of the top cover according to an exemplary embodiment of the present invention when viewed from the rear side;

FIG. 6 shows a longitudinal sectional view of a connector housing assembly according to an exemplary embodiment of the present invention, with the lever member in the unlocked position;

FIG. 7 shows a planar sectional view of a connector housing assembly according to an exemplary embodiment of the present invention, with the lever member in the unlocked position;

FIG. 8 shows a planar sectional view of a connector housing assembly according to an exemplary embodiment of the present invention, wherein the lever member is in a locked position, but the safety member has not yet been inserted into the lever member; and

FIG. 9 shows a planar sectional view of a connector housing assembly according to an exemplary embodiment of the present invention, wherein the lever member is in a locked position and the safety member has been inserted into the lever member.

### DETAILED DESCRIPTION OF THE EMBODIMENTS

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

According to an embodiment of the present invention, there is provided a connector housing assembly. The connector housing assembly comprises of: a housing; a top cover which is installed on the housing and formed with an elastic cantilever on its top wall; a lever member which is rotatably connected to the housing and can be rotated between a locked position and an unlocked position; and a safety member which is movably installed on the top cover and can be moved between a safety position that is engaged with the lever member and an initial position that is separated from the lever member. When the lever member is in the unlocked position, the elastic cantilever is in a position that interferes with the safety member to prevent the safety member from being moved from the initial position towards the safety position. When the lever member is rotated to the locked position, the lever member pushes the elastic cantilever to a position that does not interfere with the safety member, allowing the safety member to be moved from the initial position to the safety position. When the safety member is in the safety position, the lever member is held in the locked position by the safety member, so that the lever member cannot be unlocked.

According to another embodiment of the present invention, there is provided a connector. The connector comprises of: the above connector housing assembly; and a terminal which is inserted into the housing.

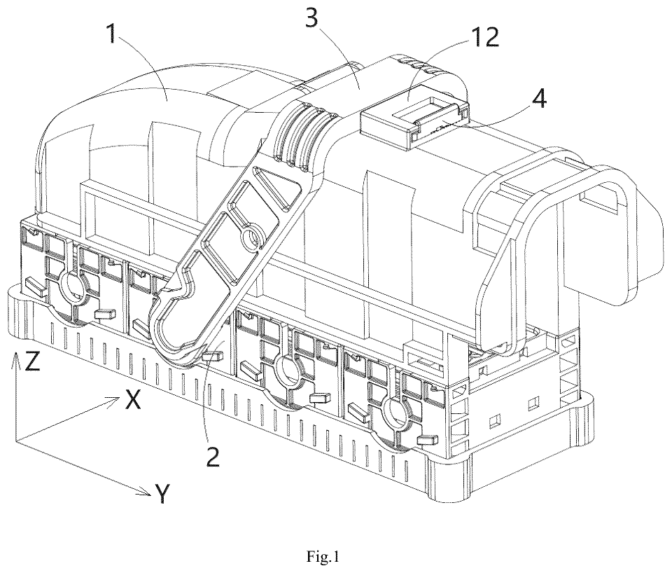

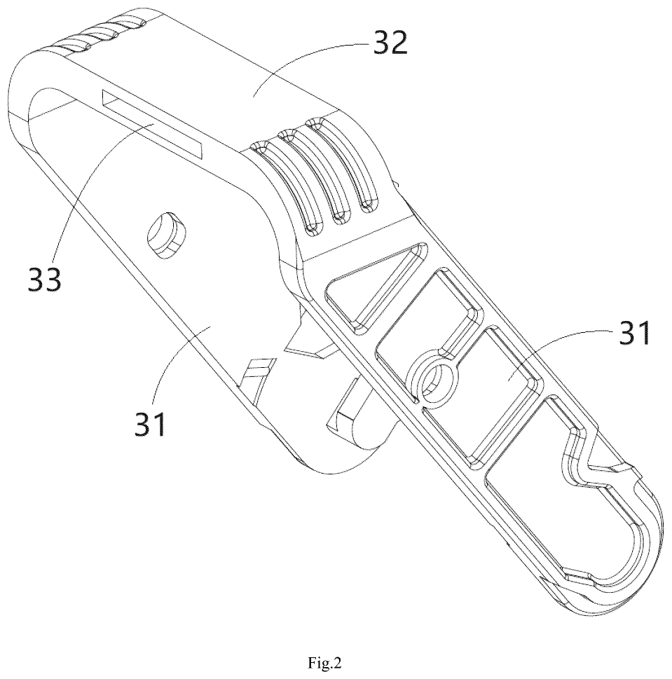

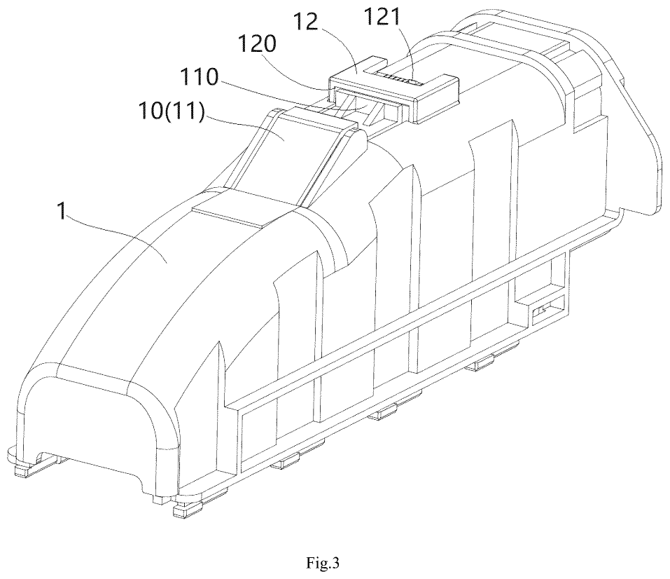

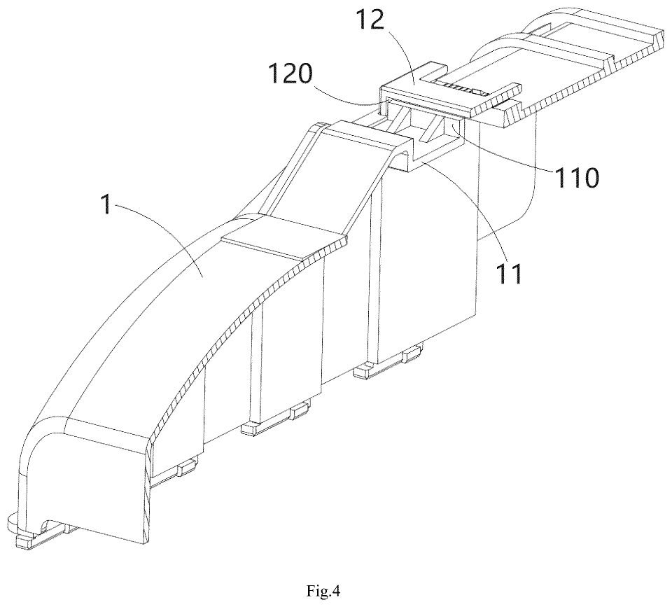

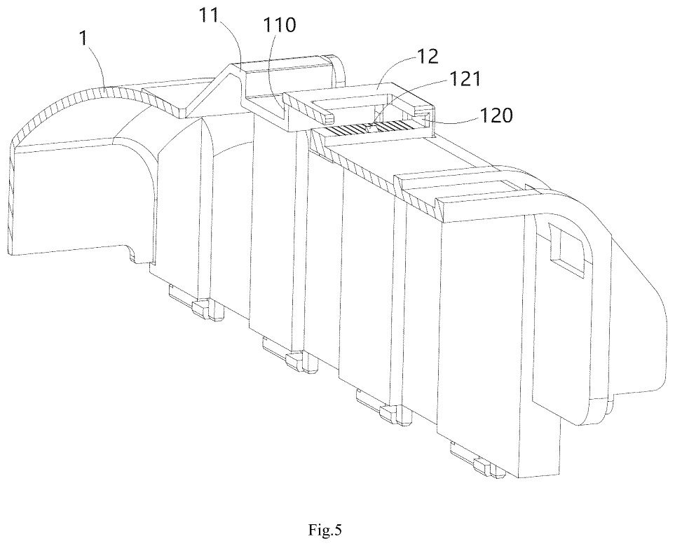

FIG. 1 shows an illustrative perspective view of a connector housing assembly according to an exemplary embodiment of the present invention. FIG. 2 shows an illustrative perspective view of a lever member 3 according to an exemplary embodiment of the present invention. FIG. 3 shows an illustrative perspective view of the top cover 1 according to an exemplary embodiment of the present invention. FIG. 4 shows a longitudinal sectional view of the top cover 1 when viewed from the front side according to an exemplary embodiment of the present invention. FIG. 5 shows a longitudinal sectional view of the top cover 1 according to an exemplary embodiment of the present invention when viewed from the rear.

As shown in FIGS. 1-5, in an exemplary embodiment of the present invention, a connector housing assembly is disclosed. The connector housing assembly includes: a top cover 1, a housing 2, a lever member 3, and a safety member 4. The top cover 1 is installed on the housing 2. An elastic cantilever 11 is formed on the top wall of the top cover 1. The lever member 3 is rotatably connected to the housing 2 and can be rotated between a locked position that locks the top cover 1 to the housing 2 and an unlocked position that allows the top cover 1 to separate from the housing 2. The safety member 4 is movably installed on the top cover 1 and can be moved between a safety position that is engaged with the lever member 3 and an initial position that is separated from the lever member 3.

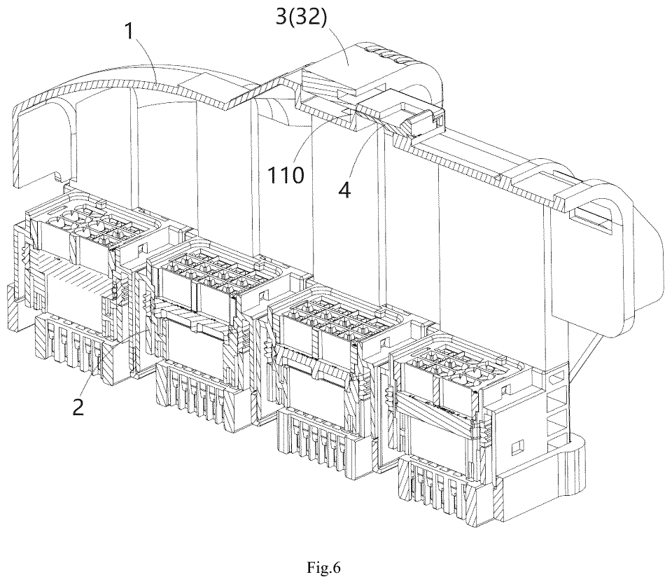

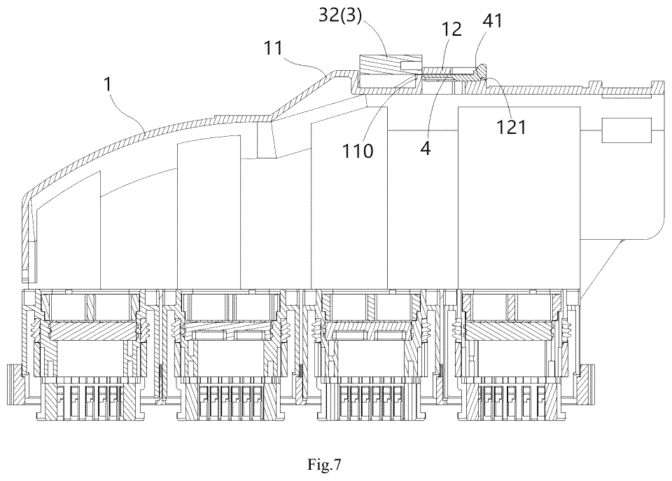

FIG. 6 shows a longitudinal sectional view of a connector housing assembly according to an exemplary embodiment of the present invention, with the lever member 3 in the unlocked position. FIG. 7 shows a planar sectional view of a connector housing assembly according to an exemplary embodiment of the present invention, with the lever member 3 in the unlocked position.

As shown in FIGS. 1-7, in the illustrated embodiments, when the lever member 3 is in the unlocked position, the elastic cantilever 11 is in an interference position with the safety member 4 to prevent the safety member 4 from being moved towards the safety position from the initial position.

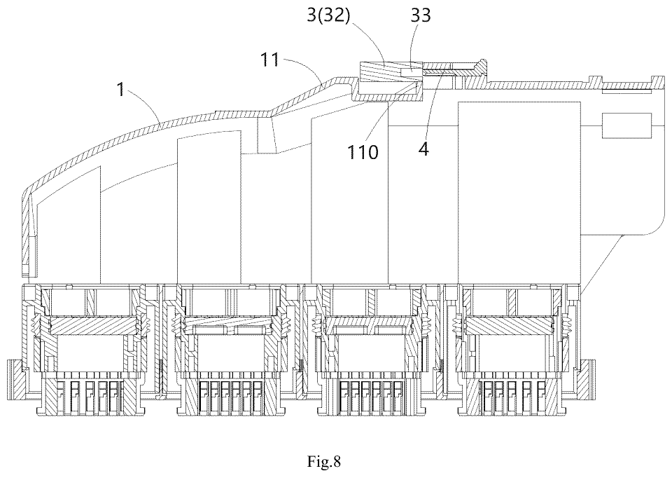

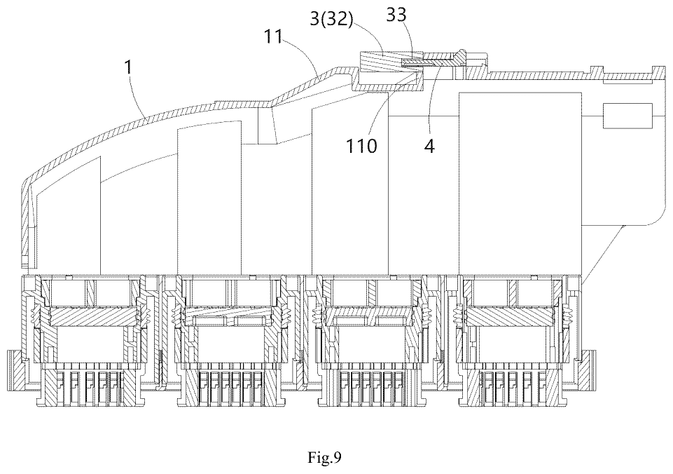

FIG. 8 shows a planar sectional view of a connector housing assembly according to an exemplary embodiment of the present invention, wherein the lever member 3 is in a locked position, but the safety member 4 has not yet been inserted into the lever member 3. FIG. 9 shows a planar sectional view of a connector housing assembly according to an exemplary embodiment of the present invention, wherein the lever member 3 is in a locked position and the safety member 4 has been inserted into the lever member 3.

As shown in FIGS. 8 and 9, in the illustrated embodiments, when the lever member 3 is rotated to the locked position, the lever member 3 pushes the elastic cantilever 11 to a position that does not interfere with the safety member 4, allowing the safety member 4 to be moved from the initial position to the safe position. In the illustrated embodiment, when the safety member 4 is in the safe position, the lever member 3 is kept in the locked position by the safety member 4, which prevents the lever member 3 from being accidentally unlocked and improves the reliability of the connector.

As shown in FIGS. 1-9, in the illustrated embodiments, the lever member 3 comprises a pair of force arms 31 and a connecting arm 32. The lower ends of the pair of force arms 31 are respectively rotatably connected to two sides of the housing 2 opposite to each other in a transverse direction of the housing 2. The connecting arm 32 is connected between the upper ends of a pair of force arms 31. An insertion slot 33 is formed on the connecting arm 32 for engaging with the safety member 4. The pair of force arms 31 of the lever member 3 are respectively located on opposite lateral sides of top cover 1, and the connecting arm 32 of the lever member 3 is located on the top wall of top cover 1.

A convex portion 12 is formed on the top wall of the top cover 1. A sliding groove 120 is formed in the convex portion 12. The sliding groove 120 runs through the convex portion 12 along a longitudinal direction Y of the top cover 1. The safety member 4 is slidably inserted into the sliding groove 120 to be able to be moved between the initial position and the safety position.

As shown in FIGS. 1-7, in the illustrated embodiments, a blocking portion 110 is formed and protruded on the end of the elastic cantilever 11, and the safety member 4 has opposite front and rear ends in the longitudinal direction Y of the top cover 1. As shown in FIGS. 6 and 7, when the lever member 3 is in the unlocked position, the blocking portion 110 is against the front end of the safety member 4 to prevent the safety member 4 from being moved from the initial position to the safe position.

The sliding slot 120 has front and rear ports opposite to each other in the longitudinal direction Y of the top cover 1. As shown in FIGS. 6 and 7, when the lever member 3 is in the unlocked position, the blocking portion 110 covers the front port of the sliding slot 120 to prevent the front end of the safety member 4 from being extended from the front port of the sliding slot 120.

As shown in FIGS. 8 and 9, when the lever member 3 is in the locked position, the blocking portion 110 is pushed by the connecting arm 32 to a position that does not obstruct the front port of the sliding slot 120, and the insertion slot 33 on the connecting arm 32 is aligned with the front port of the sliding slot 120 on the top cover 1 to allow the front end of the safety member 4 to extend from the front port of the sliding slot 120 and be inserted into insertion slot 33 on the connecting arm 32.

As shown in FIGS. 1-7, a protrusion 121 is formed on the bottom inner wall surface of the rear port of the sliding slot 120, and a positioning step 41 is formed on the bottom surface of the rear end of the safety member 4. As shown in FIGS. 6 and 7, when the lever member 3 is in the unlocked position and the safety member 4 is in the initial position, the protrusion portion 121 is against the positioning step 41 at the rear end of the safety member 4, and the blocking portion 110 is against the front end of the safety member 4 to maintain the safety member 4 in the initial position.

Multiple grooves 122 are formed on the bottom inner wall surface of the sliding slot 120 and/or the bottom surface of the safety member 4. The multiple grooves 122 extend along the longitudinal direction Y of the top cover 1 and are spaced from each other in the transverse direction X of the top cover 1 to reduce the contact area and frictional resistance between the bottom surface of the safety member 4 and the bottom inner wall surface of the sliding slot 120. This can reduce the movement resistance of the safety member 4.

As shown in FIGS. 1-9, in another exemplary embodiment of the present invention, a connector is also disclosed. The connector includes the aforementioned connector housing assembly and terminals (not shown), with the terminals inserted into housing 2.

In addition, those areas in which it is believed that those of ordinary skill in the art are familiar, have not been described herein in order not to unnecessarily obscure the invention described. Accordingly, it has to be understood that the invention is not to be limited by the specific illustrative embodiments, but only by the scope of the appended claims.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of the elements or steps, unless such exclusion is explicitly stated. Furthermore, references to “one embodiment” of the present disclosure are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. A connector housing assembly, comprising:
a housing;
a top cover installed on the housing and formed with an elastic cantilever on its top wall;
a lever member rotatably connected to the housing and rotatable between a locked position and an unlocked position; and
a safety member movably installed on the top cover and movable between a safety position that is engaged with the lever member and an initial position that is separated from the lever member, wherein:
when the lever member is in the unlocked position, the elastic cantilever is in a position that interferes with the safety member to prevent the safety member from being moved from the initial position towards the safety position;
when the lever member is rotated to the locked position, the lever member pushes the elastic cantilever to a position that does not interfere with the safety member, allowing the safety member to be moved from the initial position to the safety position; and
when the safety member is in the safety position, the lever member is held in the locked position by the safety member, so that the lever member cannot be unlocked.

2. The connector housing assembly according to claim 1, wherein the lever member includes a pair of force arms having lower ends rotatably connected to two sides of the housing opposite to each other in a transverse direction of the housing, respectively.

3. The connector housing assembly according to claim 2, wherein the lever member further includes a connecting arm which is connected between the upper ends of the pair of force arms.

4. The connector housing assembly according to claim 3, wherein an insertion slot is formed on the connecting arm for engaging with the safety member.

5. The connector housing assembly according to claim 4, wherein the pair of force arms of the lever member are respectively located on the opposite lateral sides of the top cover, and the connecting arm of the lever member is located on the top wall of the top cover.

6. The connector housing assembly according to claim 4, wherein a convex portion is formed on the top wall of the top cover, a sliding slot is formed in the convex portion that runs through the convex portion along a longitudinal direction of the top cover.

7. The connector housing assembly according to claim 6, wherein the safety member is slidably inserted into the sliding slot to be able to be moved between the initial position and the safety position.

8. The connector housing assembly according to claim 7, wherein a blocking portion is formed and protruded on the end of the elastic cantilever, and the safety member has opposite front and rear ends in the longitudinal direction of the top cover.

9. The connector housing assembly according to claim 8, wherein when the lever member is in the unlocked position, the blocking portion is against the front end of the safety member to prevent the safety member from being moved from the initial position to the safety position.

10. The connector housing assembly according to claim 9, wherein the sliding slot has front and rear ports opposite to each other in the longitudinal direction of the top cover.

11. The connector housing assembly according to claim 10, wherein when the lever member is in the unlocked position, the blocking portion covers the front port of the sliding slot to prevent the front end of the safety member from being extended out of the front port of the sliding slot.

12. The connector housing assembly according to claim 11, wherein when the lever member is in the locked position, the blocking portion is pushed by the connecting arm to a position that does not obstruct the front port of the sliding slot, and the insertion slot on the connecting arm is aligned with the front port of the sliding slot on the top cover to allow the front end of the safety member to be extended from the front port of the sliding slot and be inserted into the insertion slot on the connecting arm.

13. The connector housing assembly according to claim 7, wherein a protrusion is formed on a bottom inner wall surface of the rear end of the sliding slot, and a positioning step is formed on the bottom surface of the rear end of the safety member.

14. The connector housing assembly according to claim 13, wherein when the lever member is in the unlocked position and the safety member is in the initial position, the protrusion is against the positioning step at the rear end of the safety member, and the blocking portion is against the front end of the safety member to keep the safety member in the initial position.

15. The connector housing assembly according to claim 6, wherein multiple grooves are formed on the bottom inner wall surface of the sliding slot and/or the bottom surface of the safety member, the multiple grooves extend along the longitudinal direction of the top cover and are spaced from each other in a transverse direction of the top cover to reduce the contact area and frictional resistance between the bottom surface of the safety member and the bottom inner wall surface of the sliding slot.

16. The connector housing assembly according to claim 1, further comprising a terminal inserted into the housing.

17. A connector housing assembly, comprising:
a housing;
a top cover arranged over the housing and having an elastic cantilever formed thereon;
a lever member rotatably connected to the housing and rotatable between a locked position and an unlocked position; and
a safety member movably installed on the top cover and movable between a safety position that is engaged with the lever member and an initial position that is separated from the lever member, with the safety member is in the safety position, the lever member is held in the locked position by the safety member, so that the lever member cannot be unlocked.

18. The connector housing assembly according to claim 17, wherein with the lever member in the unlocked position, the elastic cantilever interferes with the safety member to prevent the safety member from being moved from the initial position towards the safety position.

19. The connector housing assembly according to claim 18, wherein with the lever member rotated to the locked position, the lever member biases the elastic cantilever to a position that does not interfere with the safety member and allowing the safety member to be moved from the initial position to the safety position.

20. The connector housing assembly according to claim 17, wherein the lever member includes a pair of force arms having lower ends rotatably connected to two sides of the housing opposite to each other in a transverse direction of the housing, respectively.
